(19) United States
(12) Patent Application Publication
(10) Pub. No.: US 2010/0239193 A1
(43) Pub. Date: Sep. 23, 2010

(54) LINEAR MOTION APPARATUS AND METHOD

(76) Inventor: John Martin, Easton, PA (US)

Correspondence Address: Kaplan Gilman & Pergament LLP, 1480 Route 9 North, Woodbridge, NJ, 07095, US

(21) Appl. No.: 12/407,057

(22) Filed: Mar. 19, 2009

(51) Int. Cl. F16C 29/04

(52) U.S. Cl. 384/49

(57) ABSTRACT

A sample container motion device is disclosed which may include a guide having a main channel, the main channel including at least one bearing channel; a carriage configured to move within the main channel of the guide, the carriage having at least one bearing groove corresponding to the at least one bearing channel; a slide system configured to enable linear movement between the carriage and the guide, the slide system including at least one bearing guide located in between each bearing groove and its corresponding bearing channel; wherein each bearing guide may include a plurality of ball bearings; a ball spacer having openings for the ball bearings and configured to confine centers of the ball bearings in a fixed relation to a structure of the spacer.

### BACKGROUND OF THE INVENTION

The present invention relates in general to the processing of biological samples, and in particular to isolating small portions of a single initial biological sample.

It is generally desirable to be able to obtain small quantities of a biological sample from an initial material, such as whale blubber, for various experimental purposes. In addition to obtaining precise small quantities, the material obtained must be grinded to a powder. Such grinding is typically accomplished by placing the sample into a tubular chamber, similar to a test tube, along with a ball or other striking member inside. Movement of the tubular chamber then grinds the sample.

When plural tubular chambers are used, the grinding process must be substantially identical among the chambers. One challenge that scientists face is that there exists no known apparatus for ensuring that all of the plurality of tubular chambers is oscillated in precisely the same manner.

Accordingly, there is a need in the art for improved apparatuses and methods for grinding a plurality of samples by oscillating plural tubular members simultaneously, and ensuring substantially uniform oscillatory movement and grinding among the tubular members.

### SUMMARY OF THE INVENTION

According to one aspect, the present invention is directed to a sample container motion device, that may include a guide having a main channel, the main channel including at least one bearing channel; a carriage configured to move within the main channel of the guide, the carriage having at least one bearing groove corresponding to the at least one bearing channel; a slide system configured to enable linear movement between the carriage and the guide, the slide system including at least one bearing guide located in between each bearing groove and its corresponding bearing channel; wherein each bearing guide may include a plurality of ball bearings; a ball spacer having openings for the ball bearings and configured to confine centers of the ball bearings in a fixed relation to a structure of the spacer.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a perspective view of a motion device for generating biological sample material in accordance with an embodiment of the invention;

FIG. 2A is a plan view of the motion device of FIG. 1;

FIG. 2B is a partly sectional and partially elevational end view of the motion of FIGS. 1 and 2;

FIG. 2C is a sectional side view of the motion device of FIG. 1;

FIG. 3A is an expanded sectional view of the motion device of FIG. 1;

FIG. 3B is a partly sectional and partly elevational view of one bearing assembly of the motion device of FIG. 1;

FIG. 4 is a perspective view of a guideway that may be included in the motion device of FIG. 1 in accordance with an embodiment of the invention;

FIG. 5 is a perspective view of a carriage that may be included in the motion device of FIG. 1 in accordance with an embodiment of the invention;

FIG. 6 is a planar view of a ball spacer that may be included in the motion device of FIG. 1 in accordance with an embodiment of the invention; and

FIG. 7 depicts a tray of tubular members that can be mounted atop the motion device.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

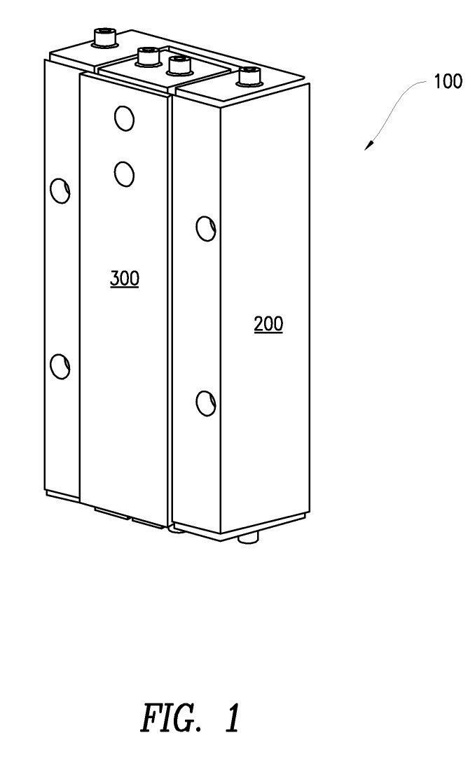

FIG. 1 is a perspective view of a motion device 100 for generating biological sample material in accordance with an embodiment of the invention. Reference is made to FIGS. 1-6 in the below discussion. In a preferred embodiment, the direction of motion of carriage 300 is vertical. However, the present invention is not limited to vertical movement.

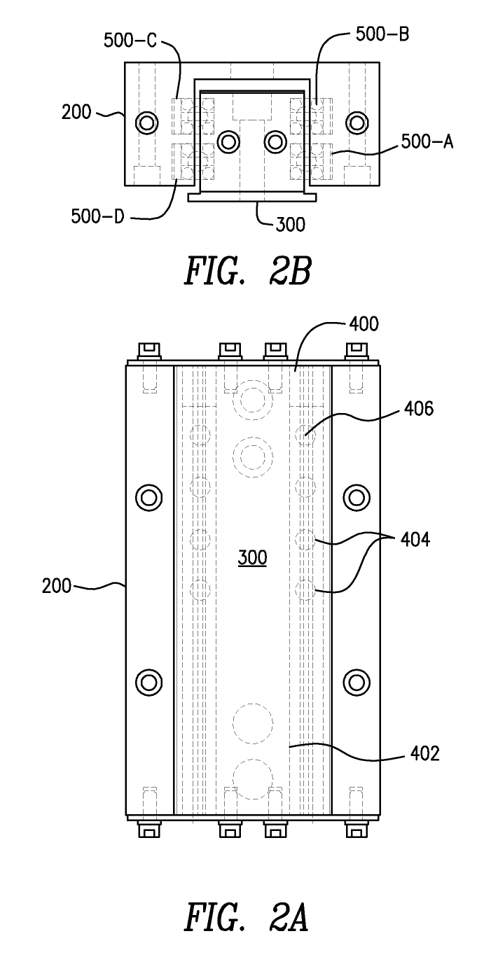

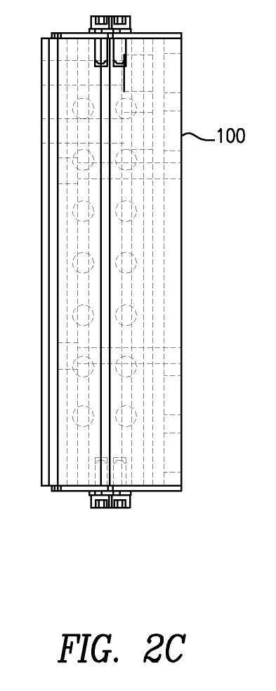

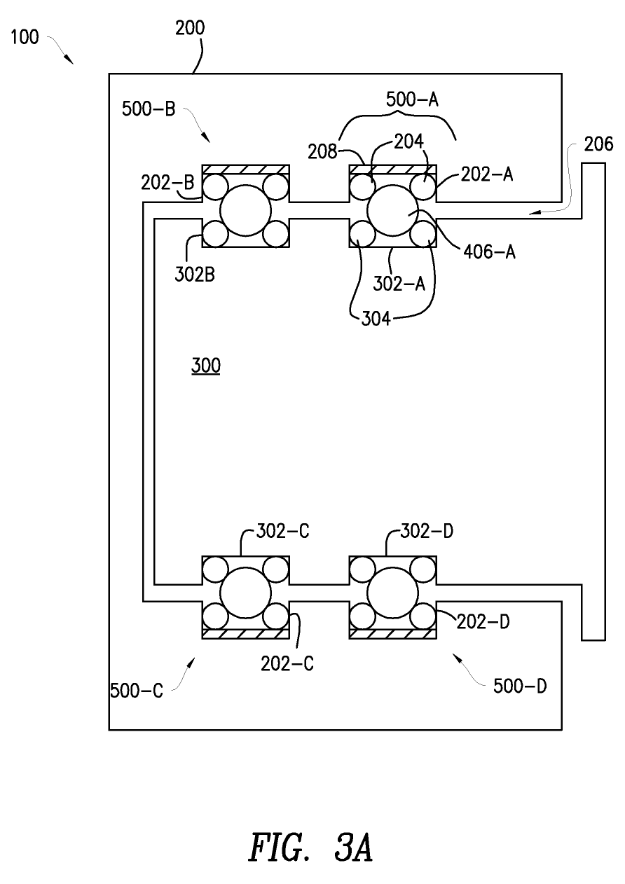

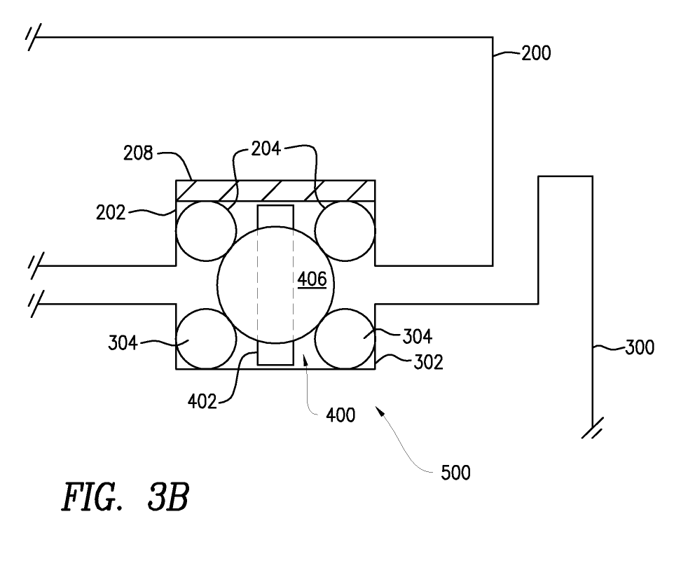

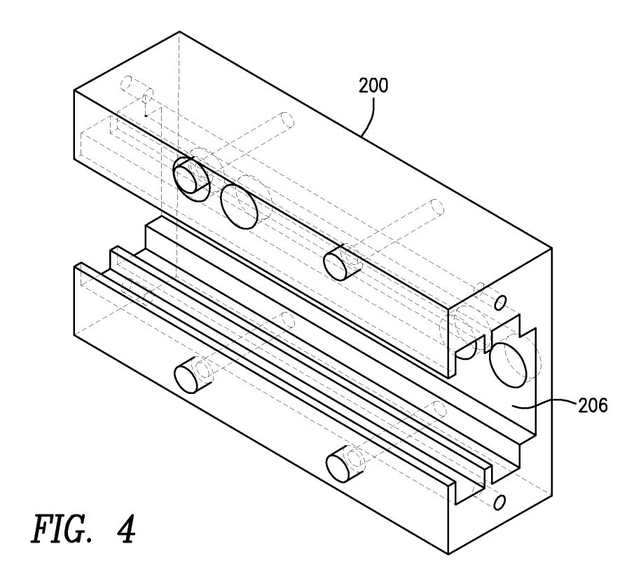

Motion device 100 may include guideway 200, carriage 300, and bearing guides 400. Guideway 200 may include main channel 206 (FIG. 4), bearing grooves 202-A, 202-B, 202-C, and/or 202-D (FIG. 3); rods 204; and/or spacer bars 208. Carriage 300 may include bearing grooves 302-A, 302-B, 302-C, and/or 302-D; and/or rods 304. Each bearing guide 400 may include ball spacer 402 (FIG. 6), ball bearings 406 (FIG. 3) which may configured in the form of an array 404 (FIG. 2A).

In one embodiment, a material sample may be placed in carriage 300. Thereafter, carriage 300 may be moved back and forth with respect to guideway 200 while being moved by an electric motor or other suitable power source such as but not limited to pneumatic, hydraulic, or other suitable power mechanism.

Isolating samples of biological or other material may involve cycling carriage 300 back and forth within guideway 200 a very large number of times, which may include hundreds of thousands or even millions of cycles. Accordingly, embodiments of the present invention benefit from stability, consistency, and linearity of the movement of carriage 300 with respect to guideway (guide) 200. Various features of the embodiments of motion device 100 discussed herein are operable to provide the above-listed characteristics.

Directing attention to FIG. 1, carriage 300 is preferably configured to move linearly within main channel 206 (FIG. 4) of guide 200. The interface between carriage 300 and guide 200 may include a plurality of bearing assemblies 500 that are configured and located within motion device 100 so as to optimize the linearity, repeatability, durability, and consistency of the motion of carriage 300 with respect to guide 200. In an embodiment of the invention, the bearing assemblies 500 (FIGS. 3A and 3B) are preferably configured to provide a durable low-friction transport interface between carriage 300 and guide 200.

In one embodiment, each bearing assembly 500 may include a bearing guide 400 having a ball spacer 402 and a plurality of ball bearings 406 in between a bearing groove 302 of carriage 300 and a bearing channel 202 of guide 200. Ball bearings 206 may experience rolling contact with rods disposed along the lengths of the carriage bearing groove 302 and the guide bearing channel 202. Bearing assemblies 500 are discussed in greater detail below in connection with FIGS. 3A and 3B.

FIG. 2A is a plan view of motion system 100 and shows carriage 300 (in the center) within guide 200. The illustrated embodiment includes four bearing assemblies 500, however only two of the four bearing assemblies are visible in the view of FIG. 2A. Directing attention to the rightmost of the two illustrated bearing assemblies, spacer 400 includes ball spacer 402 (also see FIG. 6) and array 404 of ball bearings 406. Ball spacer 402 is preferably operable to keep ball bearings 406 in fixed linear relation to one another as carriage 300 moves with respect to ball spacer 402 and with respect to guide 200.

FIG. 2A shows an embodiment in which each bearing guide 400 has a linear array 404 of ball bearings 406. However, the present invention is not limited to employing this geometry of ball bearing distribution within ball spacer 402. It will be appreciated by those having ordinary skill in the art that ball bearings 406 may be provided using a wide range of possible geometries for the distribution of ball bearings 406.

FIG. 2B is an end view of the motion system shown in FIG. 2A. In the view of FIG. 2B, four bearing assemblies 500 are visible, specifically, 500-A, 500-B, 500-C, and 500-D. In the view of FIG. 2B, the direction of motion of carriage 300 with respect to guide 200 is into and out of the page.

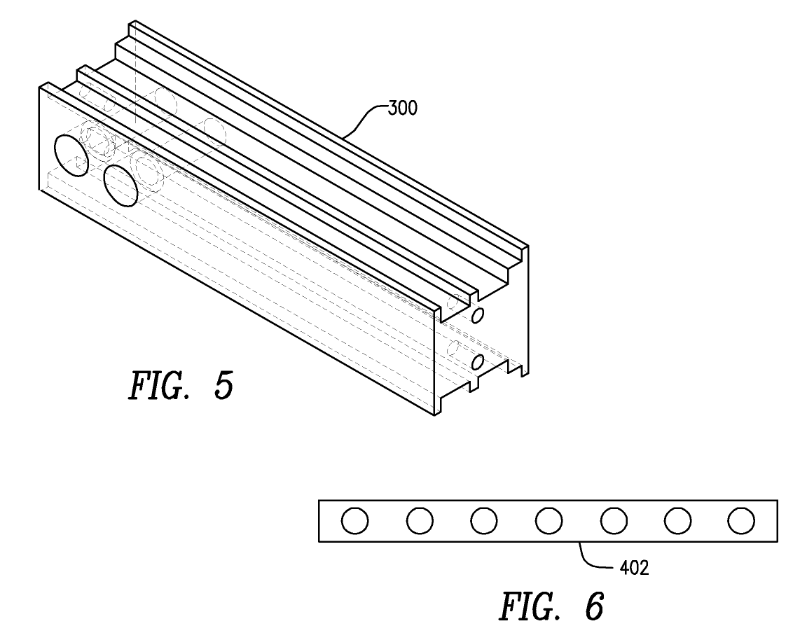

FIG. 3A is a partially sectional view and partially elevational view of the motion device 100 of FIGS. 1-2. Attention is directed to the general direction of movement of the various parts shown in FIG. 3A, followed by a more detailed discussion of the structure of guide 200 and carriage 300. In this embodiment, carriage 300 is mobile with respect to guide 200 along the main axis of motion device 100, which in the view of FIG. 3A corresponds to a direction into and out of the page. Carriage 300 is illustrated in greater detail in FIG. 5.

Guide 200 may include a plurality of channels to enable the relative motion of carriage 300 with respect to guide 200. In this embodiment, guide 200 may include main channel 206 (which is best shown in FIG. 4) which is configured to house a substantial portion of the body of carriage 300 when guide 200 and carriage 300 are assembled to one another to form motion device 100.

Motion device 100 preferably includes multiple bearing assemblies 500 (see FIG. 3A and FIG. 3B) that include parts of both guide 200 and carriage 300. Bearing assemblies 500 include the force-bearing surfaces of both guide 200, carriage 300, and of bearing guides 400 that are disposed between the pertinent portions of guide 200 and carriage 300. The totality of bearing guides 400 may be referred to collectively as a slide system. Caps 110 and 112 of FIG. 1 show flat portions that are mounted on the bottom and top using the screws shown to maintain the device in the assembled state.

The distribution of bearing assemblies 500 in motion system 100 is preferably selected to enable optimal stability and to minimize rolling resistance. In this embodiment, four bearing assemblies 500 are deployed. One set of bearing assemblies 500 is deployed on each side (an upper side and a lower side in the view of FIG. 3A) of carriage 300. Preferably, each bearing-assembly set includes two bearing assemblies 500 at separate distances from the rightmost (in the view of FIG. 3A) surface of carriage 300. In a preferred embodiment, the set of bearing assemblies 500 on each side of the carriage 300 is centered along the length of each side of the carriage 300. Otherwise stated, in this embodiment, bearings 500-B and 500-C are located about as far away from the leftmost end of main channel 206 as bearings 500-A and 500-D are from the rightmost end of main channel 206.

Guide 200 may include a plurality of bearing channels 202-A, 202-B, 202-C, and 202-D to bear the force of contact between guide 200 and to house various parts suitable for optimizing characteristics of the bearing interface between guide 200 and carriage 300. Each bearing channel 202 preferably includes a spacer bar 208 and two rods 204. Rods 204 preferably provide surfaces that ball bearings 406 of bearing guides 400 roll along to enable to the movement of carriage 300 with respect to guide 200. The spacer bar 208 may be optimally constructed from rubber or similar material with slight malleability to provide a slight “give.” The slight “give” is desired to prevent the bearings from carrying the entire force. The “give” allows some space for the system to absorb the force and permits the bearings to roll without grinding.

Herein, preferred dimensions for the parts forming guide 200, carriage 300, and bearing guide 400 are listed. While the listed dimensions are preferred, it will be appreciated that parts having dimensions (whether widths, length, thickness, or diameters) greater than or smaller than those listed may be employed, and that all such variations are intended to be included within the scope of the invention. In one embodiment, guide 200 may have a length of about 4.8 inches, and a width of about 2.75 inches. Main channel 206 may have a width of about 1.2 inches not counting the depth of the bearing channels 202. Each bearing channel 202 may have a width of about 0.368 inches and a depth of about 0.255 inches. Guide 200 may be made of anodized aluminum, but is not limited to this material. Any other suitable metal or suitable non-metallic material may be employed.

Rods 204 may have a diameter of about 0.125 inches. Spacer bar 208 may have a thickness of about 0.03 inches. Rods 204, rods 304, and spacer bar 208 may be made of stainless steel, however other materials may be employed in place of, or in addition to stainless steel for one or more of the listed parts.

Carriage 300 preferably includes a plurality of bearing grooves 302-A, 302-B, 302-C, 302-D having locations along the perimeter of carriage 300 and dimensions corresponding to the locations and dimensions, respectively, of bearing channels 202 of guide 200. Each bearing groove 302 may include rods 304 which preferably experience rolling contact with ball bearings 406 of bearing guides 400.

In one embodiment, carriage 300 may have a length (the dimension from left to right in the view of FIG. 3A) of about 4.875 inches. The width of the plate that extends beyond the width of guide main channel 206 may be about 1.36 inches. The width of the main body of guide 300 that gets placed within guide 200 main channel 206 may be about 1.12 inches. Bearing grooves 302 may have depths of about 0.22 inches and widths of about 0.368 inches. Carriage is preferably made of aluminum and preferably has a hard anodize coating. However, other suitable materials may be employed.

With reference to FIG. 3B and FIG. 6, bearing guides 400 may include a ball spacer 402, and a plurality of ball bearings 406. Ball spacer 402 is preferably operable to constrain the linear movement of the ball bearings 406, within a given bearing guide 400, with respect to one another and with respect to ball spacer 402, while allowing unrestricted rotational motion of ball bearings 406. As shown in FIG. 6, ball spacer 402 may be rectangular in shape, have a length of about four inches, a thickness of about 0.094 inches, and a width of about 0.35 inches. However, the invention is not limited to the specific dimensions listed. Ball spacer 402 preferably includes through holes distributed along its length to accommodate ball bearings 406 therein, which holes may have a diameter of about 0.226 inches. Ball spacer 402 may be made of MDS-filled Nylon. However, other suitable materials may be employed for ball spacer 402.

Each bearing assembly 500 is formed by parts belonging to guide 200, carriage 300, and bearing guide 400. FIG. 3B provides an enlarged view of bearing assembly 500-A of FIG. 3A. For the sake of simplicity, the hyphenated suffix “A” has been omitted in FIG. 3B.

A case is considered in which guide 200 is stationary, and in which carriage 300 moves “into the page” in the views of FIG. 3A and FIG. 3B. In this situation, guide 200 and rods 204 disposed within bearing channels 202 would remain stationary. Carriage 300 and rods 304 that are preferably disposed along the lengths of bearing grooves 302 would preferably move “into the page”. As carriage 300 moves, rods 304 of carriage 300 preferably experience rolling contact with ball bearings 406. Ball bearings 406 in turn experience rolling contact with rods 204 of guide 200. Thus, as the linear motion of carriage 300 continues, bearing guide 400 and ball bearings 406 forming a part thereof also move linearly with respect to guide 200. More specifically, in one embodiment, bearing guide 400 including ball bearings 406 will move about one half the linear distance traveled by carriage 300, with respect to guide 200.

Employing a motion device in accordance with the embodiments described above preferably provides highly stable, repeatable, and accurate motion of carriage 300 with respect to guide 200. Moreover, the above-described configuration is preferably able to enable very large numbers of cycles to be practiced with minimal wear on the various bearing surfaces.

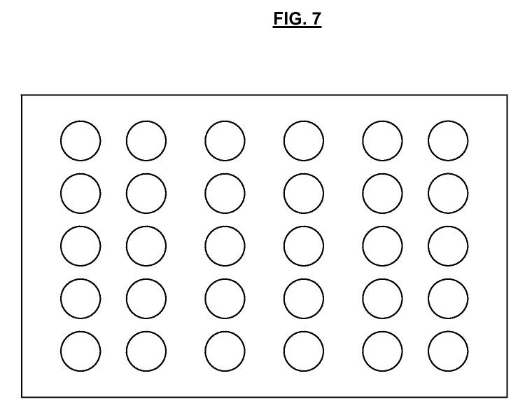

FIG. 7 depicts a matrix of tubular members that are mounted atop the central portion of the motion device as shown. As the movement of sliding device remains essentially vertical (i.e.; into and out of the page in FIG. 3), the grinding of the samples within the tubular chambers is essentially identical among the various samples.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A sample container motion device, comprising:
a guide having a main channel, the main channel including at least one bearing channel;
a carriage configured to move within the main channel of the guide, the carriage having at least one bearing groove corresponding to the at least one bearing channel;
a slide system configured to enable linear movement between the carriage and the guide, the slide system including at least one bearing guide located in between each said bearing groove and its corresponding bearing channel;
wherein each bearing guide comprises:
a plurality of ball bearings;
a ball spacer having openings for the ball bearings and configured to confine centers of the ball bearings in a fixed relation to a structure of the spacer.

2. The device of claim 1 wherein each said bearing channel of each said guide has at least two rods arranged along its length.

3. The device of claim 2 wherein each said bearing groove of each said carriage has at least two rods arranged along a length of the bearing groove.

4. The device of claim 3 wherein a first bearing guide serves as an interface between a first guide bearing channel and a corresponding first carriage bearing groove.

5. The device of claim 4 wherein the ball bearings in said bearing guide are in contact with two said rods within said first guide bearing channel and two said rods within said first carriage bearing groove.

6. The device of claim 1 wherein the ball bearings are distributed along a linear array within the bearing guide.

7. The device of claim 1 wherein the main channel of the guide has a width and a depth, and wherein the guide includes:
a first bearing channel at a first depth, into the main channel, on a first side of the channel; and
a second bearing channel opposite the first channel at said first depth and on a second side of the channel.

8. The device of claim 7 further comprising:
a third bearing channel at a second depth into the main channel, different from said first depth, on the first side of the channel; and
a fourth bearing channel at said second depth and on the second side of the channel opposite the first side.

9. The device of claim 8 further comprising:
bearing grooves on the carriage at locations corresponding to the four bearing channel locations.

10. The device of claim 9 further comprising:
a bearing guide in between each said bearing channel of the guide and its corresponding bearing groove on the carriage.

11. The device of claim 10 further comprising a matrix of tubular members mounted thereon to oscillate vertically when said device is placed in an oscillatory motion.
